(19) United States
(12) Patent Application Publication
(10) Pub. No.: US 2019/0049950 A1
(43) Pub. Date: Feb. 14, 2019

(54) DRIVING ENVIRONMENT BASED MIXED REALITY FOR COMPUTER ASSISTED OR AUTONOMOUS DRIVING VEHICLES

(71) Applicant: Intel Corporation, Santa Clara, CA (US)

(72) Inventors: Rajesh Poornachandran, Portland, OR (US); Ravishankar Iyer, Portland, OR (US); Nilesh Jain, Portland, OR (US); James Kim, Sherwood, OR (US)

(21) Appl. No.: 16/133,263

(22) Filed: Sep. 17, 2018

(51) Int. Cl. G05D 1/00; G06T 19/00

(52) U.S. Cl. CPC G05D 1/0044; G05D 2201/0213; G05D 1/0088; G06T 19/006

(57) ABSTRACT

Embodiments include apparatuses, methods, and systems for computer assisted or autonomous driving (CA/AD). An apparatus for CA/AD may include a data aggregation unit, an environment mapping unit coupled to the data aggregation unit, and a mixed reality content unit coupled to the environment mapping unit. The data aggregation unit collects data from one or more data sources. The environment mapping unit determines, based at least in part on the collected data from the one or more data sources or historical environment data, information about a driving environment associated with a route for the CA/AD vehicle. The mixed reality content unit determines a mixed reality content to be presented to a user according to the information about the driving environment associated with the route to generate an immersive mixed reality experience for the user. Other embodiments may also be described and claimed.

### FIELD

Embodiments of the present disclosure relate generally to the technical fields of computer assisted or autonomous driving, and more particularly to providing driving environment based mixed reality to computer assisted or autonomous driving vehicles.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Computer assisted or autonomous driving (CA/AD) vehicles are becoming more and more popular. CA/AD vehicles are not only set to change the automotive industry, but users of CA/AD vehicles also expect revolutionized driving experience.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example driving environment associated with a route for a computer assisted or autonomous driving (CA/AD) vehicle to present a mixed reality content to a user according to information about the driving environment, in accordance with various embodiments.

FIG. 2 illustrates an example onboard unit (OBU) of a CA/AD vehicle to present a mixed reality content to a user according to information about driving environment associated with a route for a CA/AD vehicle, in accordance with various embodiments.

FIG. 3 illustrates an example operational flow to present a mixed reality content to a user of a CA/AD vehicle according to information about driving environment, in accordance with various embodiments.

FIG. 4 illustrates an example process for presenting a mixed reality content to a user of a CA/AD vehicle according to information about driving environment, in accordance with various embodiments.

FIG. 5 illustrates an example neural network suitable for use with present disclosure, in accordance with various embodiments.

FIG. 6 illustrates a software component view of a system to present a mixed reality content to a user according to information about driving environment, in accordance with various embodiments.

FIG. 7 illustrates a hardware component view of a computing platform to present a mixed reality content to a user according to information about driving environment, in accordance with various embodiments.

FIG. 8 illustrates a storage medium having instructions for practicing methods described with references to FIGS. 1-7, in accordance with various embodiments.

### DETAILED DESCRIPTION

A driver or passengers of a vehicle of current generation can do only limited entertainment inside the vehicle to avoid the unnecessary distraction to the driver. Computer assisted or autonomous driving (CA/AD) vehicles are expected to have more powerful computing capability that can potentially facilitate provision of higher quality in-vehicle-infotainment (IVI) to improve user experiences. Examples of these higher quality IVI include augmented reality (AR), virtual reality (VR), or mixed reality (MR), based on smart panoramic displays and/or surround sound systems with various sensors for immersive MR experience. Mixed reality or hybrid reality, encompassing both AR and VR, may merge real and virtual worlds to produce new environments and visualizations where physical and digital objects co-exist and interact in real time.

Current mixed reality systems, e.g., flight simulators, may deliver a virtual experience to a user, without factoring actual driving or flying environment of the user. For example, a flight simulator may provide a virtual experience based on past flying environments and/or experience, but without factoring in real-time actual flying environments. Further, a flight simulator is typically controlled by user responses (e.g. using joystick). Driving vehicles of current generation may support navigation choices related to speed or time, e.g., fastest route, shortest distance, to avoid freeway, etc. but they do not provide immersive mixed reality experience for the user of a vehicle. Embodiments of the present disclosure deliver a personalized immersive mixed reality experience with contextual relevance of the users as well as driving environment associated with a route for a CA/AD vehicle. A CA/AD vehicle may select a route based on an immersive mixed reality experience generated for the user of the CA/AD vehicle, according to information about driving environment.

In embodiments, an apparatus for CA/AD includes a data aggregation unit, an environment mapping unit coupled to the data aggregation unit, and a mixed reality content unit coupled to the environment mapping unit. The data aggregation unit is configured to collect data from one or more data sources. The environment mapping unit is configured to determine, based at least in part on the collected data from the one or more data sources or historical environment data, information about a driving environment associated with a route for the CA/AD vehicle. The mixed reality content unit is configured to determine a mixed reality content to be presented to a user according to the information about the driving environment associated with the route to generate an immersive mixed reality experience for the user.

In embodiments, a method for CA/AD is performed by a device, e.g., an onboard unit (OBU) of a CA/AD vehicle. The method includes collecting, by a data aggregation unit of a CA/AD vehicle, data from one or more data sources; and determining, by an environment mapping unit of the CA/AD vehicle, based at least in part on the collected data from the one or more data sources or historical environment data, information about a driving environment associated with a route for the CA/AD vehicle. The method further includes determining, by a mixed reality content unit of the CA/AD vehicle, a mixed reality content to be presented to a user according to the information about the driving environment associated with the route to generate an immersive mixed reality experience for the user.

In embodiments, one or more non-transitory computer-readable media are configured with instructions that cause a CA/AD system in a CA/AD vehicle, in response to execution of the instructions by the CA/AD system, to collect data from one or more data sources; determine, based at least in part on the collected data from the one or more data sources or historical environment data, information about a driving environment associated with a route for the CA/AD vehicle; and determine a mixed reality content to be presented to a user according to the information about the driving environment associated with the route to generate an immersive mixed reality experience for the user.

In the description to follow, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

As used herein, the term semi-autonomous driving is synonymous with computer-assisted driving. The term does not mean exactly 50% of the driving functions are automated. The percentage of automated driving functions may vary between 0% and 100%. In addition, it will be appreciated that the hardware, circuitry and/or software implementing the semi-autonomous driving may temporarily provide no automation, or 100% automation, such as in response to an emergency situation.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A or B” and “A and/or B” means (A), (B), or (A and B). For the purposes of the present disclosure, the phrase “A, B, and/or C” means (A), (B), (C), (A and B), (A and C), (B and C), or (A, B and C).

The terminology used herein is for the purpose of describing particular embodiments only and is not intended to be limiting of the disclosure. As used herein, the singular forms “a,” “an” and “the” are intended to include plural forms as well, unless the context clearly indicates otherwise. The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

As used hereinafter, including the claims, the term “unit,” “module,” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “processor circuitry” may refer to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

As used herein, the term “interface” or “interface circuitry” may refer to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like).

As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources. Examples of “computer devices”, “computer systems”, etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management Systems (EEMSs), electronic/engine control units (ECUs), vehicle-embedded computer devices (VECDs), autonomous or semi-autonomous driving vehicle (hereinafter, simply ADV) systems, in-vehicle navigation systems, electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

As used herein, the term “network element” may be considered synonymous to and/or referred to as a networked computer, networking hardware, network equipment, router, switch, hub, bridge, radio network controller, radio access network device, gateway, server, and/or any other like device. The term “network element” may describe a physical computing device of a wired or wireless communication network and be configured to host a virtual machine. Furthermore, the term “network element” may describe equipment that provides radio baseband functions for data and/or voice connectivity between a network and one or more users. The term “network element” may be considered synonymous to and/or referred to as a “base station.” As used herein, the term “base station” may be considered synonymous to and/or referred to as a node B, an enhanced or evolved node B (eNB), next generation nodeB (gNB), base transceiver station (BTS), access point (AP), roadside unit (RSU), etc., and may describe equipment that provides the radio baseband functions for data and/or voice connectivity between a network and one or more users. As used herein, the terms “vehicle-to-vehicle” and “V2V” may refer to any communication involving a vehicle as a source or destination of a message. Additionally, the terms “vehicle-to-vehicle” and “V2V” as used herein may also encompass or be equivalent to vehicle-to-infrastructure (V2I) communications, vehicle-to-network (V2N) communications, vehicle-to-pedestrian (V2P) communications, or V2X communications.

As used herein, the term “channel” may refer to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for the purpose of transmitting and receiving information.

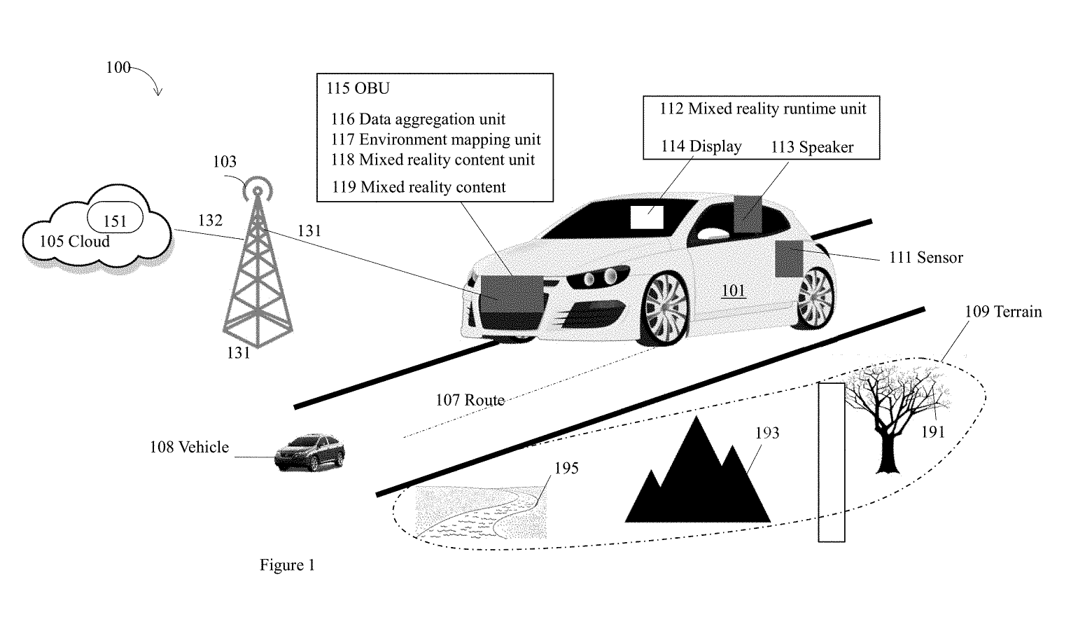

FIG. 1 illustrates an example driving environment 100 associated with a route 107 for a CA/AD vehicle 101 to present a mixed reality content 119 to a user according to information about the driving environment, in accordance with various embodiments. For clarity, features of the driving environment 100, the CA/AD vehicle 101, the route 107, and the mixed reality content 119 are described below as an example for understanding an example driving environment for a CA/AD vehicle to present a mixed reality content to a user according to information about the driving environment. It is to be understood that there may be more or fewer components included in the driving environment 100, the CA/AD vehicle 101, the route 107, and the mixed reality content 119. Further, it is to be understood that one or more of the devices and components within the driving environment 100, the CA/AD vehicle 101, the route 107, and the mixed reality content 119 may include additional and/or varying features from the description below, and may include any devices and components that one having ordinary skill in the art would consider and/or refer to as the devices and components of a driving environment for a CA/AD vehicle to present a mixed reality content to a user according to information about the driving environment.

In embodiments, the driving environment 100 includes a two dimensional (2D) freeway/highway/roadway environment. The environment 100 includes the CA/AD vehicle 101, a roadside unit (RSU) 103, and a cloud computing environment (“cloud” for short) 105. [As used herein, unless the context clearly indicates otherwise, the term “cloud” does not refer to a visible mass of condensed water vapor floating in the atmosphere/sky.] The cloud 105 includes a number of cloud servers 151, which may include e.g., an application server. The communication between the RSU 103, the cloud 105, or the cloud server 151, and the CA/AD vehicle 101 may be a part of a vehicle-to-infrastructure (V2I) communications. For example, the CA/AD vehicle 101 may communicate with the RSU 103, the cloud 105, or the cloud server 151, via a wireless technology 131. The wireless technology 131 may include a selected one of dedicated short range communications (DSRC) technology, Bluetooth technology, wireless fidelity (WiFi) technology, wireless local network (WLAN), cellular wireless network technology, short range radio technology, or any other wireless technology. In addition, the RSU 103 may communicate with the cloud 105 by a link 132, which may be a wireless or wired connection.

In embodiments, the driving environment 100 also includes information about a terrain 109 along the route 107. In some embodiments, information about the terrain 109 along the route 107 may include a slope of the route 107, one or more turns of the route 107, or one or more objects along the route 107, e.g., a tree 191, a mountain 193, or a river 195.

In embodiments, the driving environment 100 may also include information about real-time traffic on the route 107, or road conditions of the route 107. For example, the information about the real-time traffic on the route 107 may include a position of the CA/AD vehicle 101 relative to a driving lane, a speed of the CA/AD vehicle 101, an inter-vehicle distance of the CA/AD vehicle 101 with another vehicle 108, a position with a lane or across lanes for the CA/AD vehicle 101, a choice of a lane among multiple lanes for the CA/AD vehicle 101, a degree of a turn to make for the CA/AD vehicle 101, and/or a trajectory of the CA/AD vehicle 101.

In embodiments, the CA/AD vehicle 101 includes a vehicle onboard unit (OBU) 115, a mixed reality runtime unit 112, and various sensors, e.g., a sensor 111. The OBU 115 includes a data aggregation unit 116, an environment mapping unit 117, and a mixed reality content unit 118. In some other embodiments, the data aggregation unit 116, the environment mapping unit 117, and the mixed reality content unit 118 may be disposed in other places of the CA/AD vehicle 101, instead of within the OBU 115. There may be other components of the CA/AD vehicle 101 not shown.

The data aggregation unit 116 is configured to collect data from one or more data sources, e.g., the sensor 111, or other devices. The data from the one or more data sources, e.g., the sensor 111, include user input data, sensory data, crowd-sourced input data from another device, another vehicle, others users, and/or a RSU, e.g., the RSU 103. The sensory data may include one or more selected from radar data, ultrasonic sensor data, video sensor data, camera data, light detection and ranging (LiDAR) data, global positioning system (GPS) data, or inertial data.

The environment mapping unit 117 is configured to determine information about the driving environment 100 associated with the route 107 for the CA/AD vehicle 101, based at least in part on the collected data from the one or more data sources or historical environment data. The mixed reality content unit 118 is configured to determine a mixed reality content, e.g., the mixed reality content 119, to be presented to a user according to the information about the driving environment 100 associated with the route 107. In embodiments, the mixed reality content, e.g., the mixed reality content 119, is presented by the mixed reality runtime unit 112, including e.g., a display 114, a speaker 113, or other devices, to the user to generate an immersive mixed reality experience for the user. In embodiments, the mixed reality content 119 may include visual content displayed by the display 114, audio content played by the speaker 113, mechanical movements of one or more parts of the CA/AD vehicle, and/or air movements within or around the CA/AD vehicle.

In embodiments, the immersive mixed reality experience generated by the mixed reality content 119 includes an indicator generated based on the collected data from the one or more data sources. For example, a datum from a data source, e.g., the sensor 111, may have an associated sensitivity level to the user. In embodiments, the immersive mixed reality experience generated by the mixed reality content 119 is also dependent on an application to present the mixed reality content 119, and user feedback from the user in response to the presented mixed reality content 119. In addition, immersive mixed reality experience generated by the mixed reality content 119 may further depend on user profile data, a security measure of the application, a risk factor for the mixed reality content 119, and/or an opportunity cost for the mixed reality content 119.

For example, a family travelling on a CA/AD vehicle 101, e.g., a minivan, may have an immersive mixed reality experience generated by the mixed reality content 119 with photo realistic visuals of safari dessert, along with surround sound. Based on the real-time traffic and information about the terrain 109 being navigated by the CA/AD vehicle 101, dynamic mixed reality content can be rendered with vibrating experience on seats and air blowing to the passenger to simulate flying. The environment mapping unit 117 may constantly scan the surround driving environment, and the mixed reality content unit 118 may determine the mixed reality content 119 to be played based on the driving environment. For example, when the CA/AD vehicle 101 turns a corner, the environment mapping unit 117 may anticipate the change of the driving environment, and the mixed reality content unit 118 may adjust the mixed reality content 119 to demonstrate a chase scene by an animal, where the chase scene may be adjusted/prolonged so that the passengers can narrowly escape the chase just as the CA/AD vehicle 101 turns the corner.

In embodiments, the CA/AD vehicle 101 may be any type of motorized vehicle or device used for transportation of people or goods, which may be equipped with controls used for driving, parking, passenger comfort and/or safety, etc. The terms “motor”, “motorized”, etc., as used herein may refer to devices that convert one form of energy into mechanical energy, and may include internal combustion engines (ICE), compression combustion engines (CCE), electric motors, and hybrids (e.g., including an ICE/CCE and electric motor(s)). For example, the CA/AD vehicle 101 is a selected one of a commercial truck, a light duty car, a sport utility vehicle (SUV), a light vehicle, a heavy duty vehicle, a pickup truck, a van, a car, or a motorcycle.

In embodiments, the RSU 103 may be one or more hardware computer devices configured to provide wireless communication services to mobile devices (for example, OBU 115 in the CA/AD vehicle 101 or some other suitable device) within a coverage area or cell associated with the RSU 103. The RSU 103 includes a transmitter/receiver (or alternatively, a transceiver) connected to one or more antennas, one or more memory devices, one or more processors, one or more network interface controllers, and/or other like components. The one or more transmitters/receivers are configured to transmit/receive data signals to/from one or more mobile devices via a link. Furthermore, one or more network interface controllers are configured to transmit/receive with various network elements (e.g., one or more servers within a core network, etc.) over another backhaul connection (not shown).

As an example, the RSU 103 may be a base station associated with a cellular network (e.g., an eNB in an LTE network, a gNB in a new radio access technology (NR) network, a WiMAX base station, etc.), a remote radio head, a relay radio device, a small cell base station (e.g., a femtocell, picocell, home evolved nodeB (HeNB), and the like), or other like network element. In addition, the RSU 103 may be a road embedded reflector, a smart street or traffic light, a road side tag, or a stationary user equipment (UE) type RSU.

In embodiments, the cloud 105 may represent the Internet, one or more cellular networks, a local area network (LAN) or a wide area network (WAN) including proprietary and/or enterprise networks, transfer control protocol (TCP)/internet protocol (IP)-based network, or combinations thereof. In such embodiments, the cloud 105 may be associated with network operator who owns or controls equipment and other elements necessary to provide network-related services, such as one or more base stations or access points (e.g., the RSU 103), one or more servers for routing digital data or telephone calls (for example, a core network or backbone network), etc. Implementations, components, and protocols used to communicate via such services may be those known in the art and are omitted herein for the sake of brevity.

In some embodiments, the cloud 105 may be a system of computer devices (e.g., servers, storage devices, applications, etc. within or associated with a data center or data warehouse) that provides access to a pool of computing resources. The term “computing resource” refers to a physical or virtual component within a computing environment and/or within a particular computer device, such as memory space, processor time, electrical power, input/output operations, ports or network sockets, and the like. In these embodiments, the cloud 105 may be a private cloud, which offers cloud services to a single organization; a public cloud, which provides computing resources to the general public and shares computing resources across all customers/users; or a hybrid cloud or virtual private cloud, which uses a portion of resources to provide public cloud services while using other dedicated resources to provide private cloud services. For example, the hybrid cloud may include a private cloud service that also utilizes one or more public cloud services for certain applications or users, such as providing obtaining data from various data stores or data sources. In embodiments, a common cloud management platform (e.g., implemented as various virtual machines and applications hosted across the cloud 105 and database systems) may coordinate the delivery of data to the OBU 115 of the CA/AD vehicle 101. Implementations, components, and protocols used to communicate via such services may be those known in the art and are omitted herein for the sake of brevity.

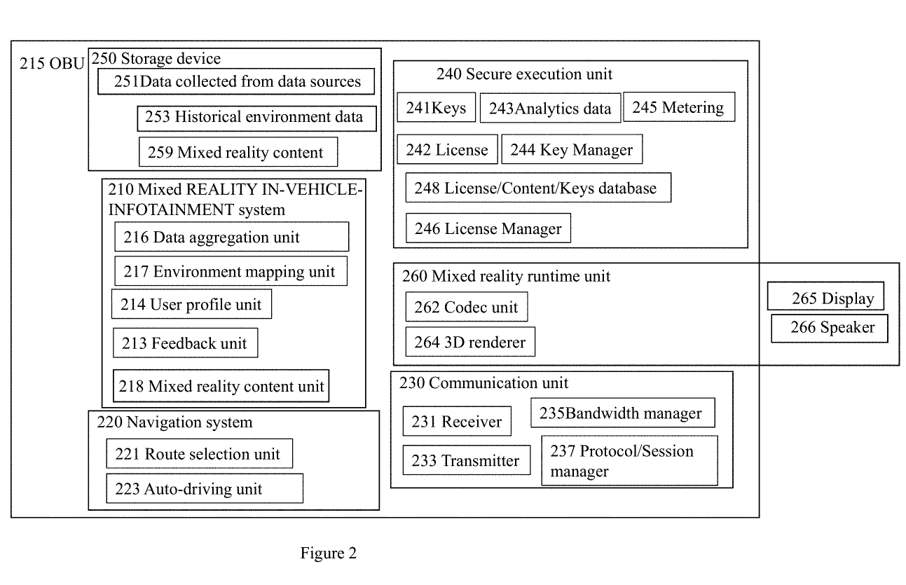

FIG. 2 illustrates an example OBU 215 of a CA/AD vehicle to present a mixed reality content 259 to a user according to information about driving environment associated with a route for the CA/AD vehicle, in accordance with various embodiments. In embodiments, the OBU 215 and the mixed reality content 259 may be similar to the OBU 115 disposed on the CA/AD vehicle 101, and the mixed reality content 119 presented to a user according to information about driving environment 100 associated with the route 107 for the CA/AD vehicle 101, as described in FIG. 1.

In embodiments, the OBU 215 includes a mixed reality in-vehicle-infotainment system 210, a navigation system 220, a communication unit 230, a secure execution unit 240, a storage device 250, and a mixed reality runtime unit 260, in addition to other components not shown. In detail, for the illustrated embodiments, the mixed reality in-vehicle-infotainment system 210 includes a data aggregation unit 216, an environment mapping unit 217, and a mixed reality content unit 218, which may be similar to the data aggregation unit 116, the environment mapping unit 117, and the mixed reality content unit 118 as shown in FIG. 1. In embodiments, the data aggregation unit 216 collects data from one or more data sources, while the environment mapping unit 217 determines, based at least in part on the collected data 251 from the one or more data sources or historical environment data 253 stored in the storage device 250, information about a driving environment associated with a route for the CA/AD vehicle. The historical environment data 253 may be data about the route for the CA/AD vehicle, which are from previous trips by other vehicles, or from one or more RSUs. In addition, the mixed reality content unit 218 determines the mixed reality content 259 to be presented to a user according to the information about the driving environment associated with the route to generate an immersive mixed reality experience for the user.

In embodiments, the mixed reality in-vehicle-infotainment system 210 or the OBU 215 may further include a feedback unit 213, and a user profile unit 214 coupled to other components of the OBU 215, e.g., the mixed reality content unit 218. The feedback unit 213, when included, provides user feedback from the user in response to the presented mixed reality content 259, and the mixed reality content unit 218 may adjust the mixed reality content 259, according to the information about the driving environment and the user feedback, to be presented to the user. The user profile unit 214, when included, is coupled to the mixed reality content unit 218 to provide user profile data to the mixed reality content unit 218. The mixed reality content unit 218 adjusts the mixed reality content 259, further according to the information about the driving environment and the user profile data, to be presented to the user. The user profile data may include responses from the user to one or more mixed reality contents, parameters configured for the user, risk tolerance level for the user, or information about quality of service (QoS) for the user.

In embodiments, the OBU 215 further includes the secure execution unit 240 coupled to the mixed reality content unit 218. The secure execution unit 240 is configured to manage licenses, or keys associated with the mixed reality content 259 to be presented to the user. For example, the secure execution unit 240 may include keys 241 and licenses 242, which may be stored in license/content/keys database 248, and managed by key manager 244, or license manager 246. The secure execution unit 240 is configured to include analytics data 243, or metering function 245 to monitor the presentation of the mixed reality content 259.

In embodiments, the OBU 215 further includes the navigation system 220, which may be coupled to the mixed reality content unit 218. The navigation system 220 may include a route selection unit 221 to choose a route among a plurality of routes for the CA/AD vehicle, based on the immersive mixed reality experience generated for the user based on the mixed reality content 259 presented to the user. The navigation system 220 may further include an auto-driving unit 223.

In some embodiments, the immersive mixed reality experience includes an indicator generated based on the collected data from the one or more data source where a datum has an associated sensitivity level to the user, an application to present the mixed reality content, the mixed reality content presented to the user, user feedback from the user in response to the presented mixed reality content, user profile data, a security measure of the application, a risk factor for the mixed reality content, or an opportunity cost for the mixed reality content.

In embodiments, the OBU 215 further includes a communication unit 230. The communication unit 230 may include a receiver 231, a transmitter 233, a bandwidth manager 235, and a protocol/session manager 237, to manage the communication with RSUs for the CA/AD vehicle along the route, manage the bandwidth, sessions, and protocols for the presentation of the mixed reality content 259.

In embodiments, the OBU 215 further includes the mixed reality runtime unit 260 to present the mixed reality content 259 by various devices, e.g., a display 265 or a speaker 266. The mixed reality runtime unit 260 may include a codec unit 262 for coding and decoding of the mixed reality content 259, and a 3D renderer 264 to present the mixed reality content 259 by the display 265 or the speaker 266.

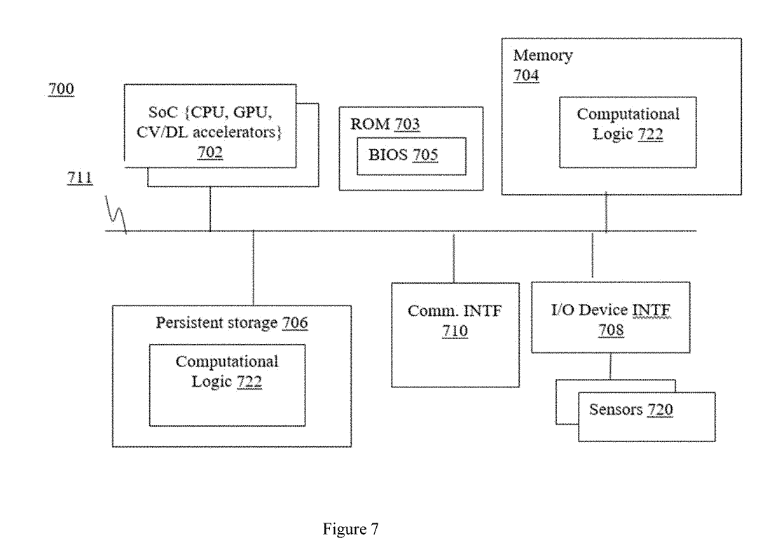

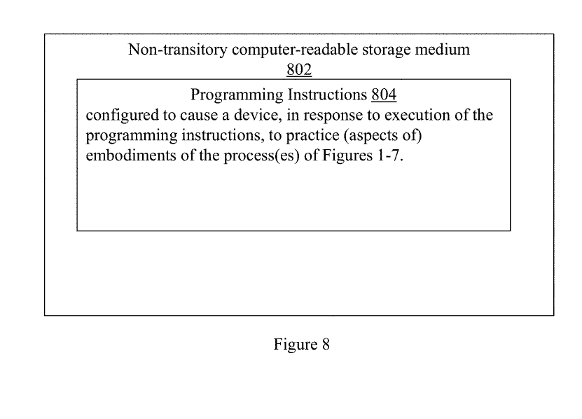

In embodiments, the OBU 215 may be any type of computer device that is mounted on, built into, or otherwise embedded in a vehicle and is capable of performing operations. In some embodiments, the OBU 215 may be a computer device used to control one or more systems of the CA/AD vehicle 101, such as an ECU, ECM, embedded system, microcontroller, control module, EMS, OBD devices, DME, MDTs, etc. The OBU 215 may include one or more processors (having one or more processor cores and optionally, one or more hardware accelerators), memory devices, communication devices, etc. that may be configured to carry out various functions according to the various embodiments discussed here. For example, the OBU 215 may be the computing platform 700 shown in FIG. 7, and may execute instructions stored in a computer-readable medium, e.g., the computer-readable medium 802 as shown in FIG. 8, or may be pre-configured with the logic (e.g., with appropriate bit streams, logic blocks, etc.). In embodiments, the OBU 215 may be implemented in hardware, e.g., ASIC, or programmable combinational logic circuit (e.g., (FPGA)), or software (to be executed by a processor and memory arrangement), or combination thereof.

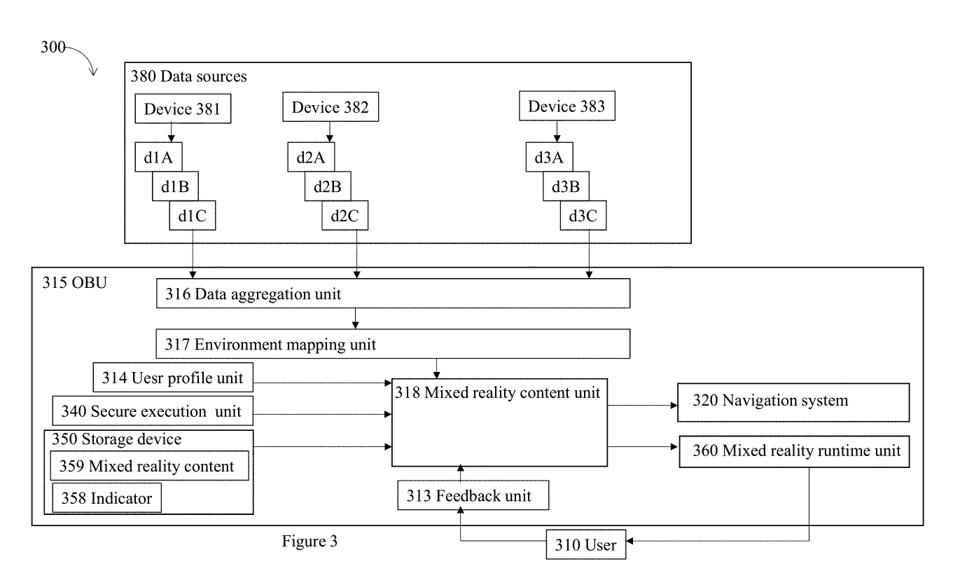

FIG. 3 illustrates an example operational flow to present a mixed reality content 359 to a user 310 of a CA/AD vehicle 300 according to information about driving environment, in accordance with various embodiments. In embodiments, the operational flow are performed by components within an OBU 315 of the CA/AD vehicle 300, where the OBU 315 and the mixed reality content 359 may be similar to the OBU 115 disposed on the CA/AD vehicle 101, and the mixed reality content 119 presented to a user according to information about driving environment 100 associated with the route 107 for the CA/AD vehicle 101, as described in FIG. 1.

In embodiments, the CA/AD vehicle 300 includes the OBU 315, and one or more data sources 380, e.g., a device 381, a device 382, and a device 383. The OBU 315 includes a data aggregation unit 316, an environment mapping unit 317, and a mixed reality content unit 318, which may be similar to the data aggregation unit 116, the environment mapping unit 117, and the mixed reality content unit 118 as shown in FIG. 1. In addition, the OBU 315 includes a user profile unit 314, a feedback unit 313, a secure execution unit 340, a navigation system 320, a storage device 350 to store the mixed reality content 359, and a mixed reality runtime unit 360. There may be other units, components, or subsystems of the OBU 315, not shown.

In embodiments, the one or more data sources 380, e.g., the device 381, the device 382, and the device 383 may be sensors that may be operated continuously to collect data, e.g., d1A, d1B, and d1C for the device 381, d2A, d2B, and d2C for the device 382, and d3A, d3B, and d3C for the device 383, about a driving environment associated with a route for the CA/AD vehicle 300. The device 381, the device 382, and the device 383 may include various kinds of sensors, e.g., camera, GPS, ultrasonic sensor, radar, video sensor, LiDAR, inertial sensor, and so forth. In some embodiments, the data generated by the one or more data sources 380 may include various data packets and/or data streams, navigation signaling/data (e.g., global navigation satellite system (GNSS), GPS, etc.), and/or the like.

In embodiments, the data aggregation unit 316 is configured to collect data from the one or more data sources 380, while the environment mapping unit 317 may determine, based at least in part on the collected data from the one or more data sources 380 or historical environment data stored in the storage device 350, information about a driving environment associated with a route for the CA/AD vehicle 300. In addition, the mixed reality content unit 318 is configured to determine the mixed reality content 359 to be presented to the user 310 according to the information about the driving environment associated with the route to generate an immersive mixed reality experience for the user 310.

In embodiments, the user profile unit 314 is coupled to the mixed reality content unit 318 and configured to provide user profile data to the mixed reality content unit 318. The mixed reality content unit 318 is configured to adjust the mixed reality content 359, further according to user profile data, to be presented to the user 310. The secure execution unit 340 is coupled to the mixed reality content unit 318 and configured to manage licenses, or keys associated with the mixed reality content 359 to be presented to the user.

In embodiments, the feedback unit 313 is configured to provide user feedback from the user 310 in response to the presented mixed reality content 359. The mixed reality content unit 318 is configured to adjust the mixed reality content 359 to be presented to the user 310, according to the information about the driving environment and the user feedback.

In embodiments, the mixed reality runtime unit 360 is configured to present the mixed reality content 359 by various devices, e.g., a display or a speaker, to the user 310 according to the information about the driving environment associated with the route to generate an immersive mixed reality experience for the user 310. In some embodiments, the immersive mixed reality experience has an associated indicator 358 generated based on the collected data from the one or more data sources 380, an application to present the mixed reality content 359, the mixed reality content 359 presented to the user, the user feedback from the user 310 in response to the presented mixed reality content 359, the user profile data, a security measure of the application, a risk factor for the mixed reality content, and/or an opportunity cost for the mixed reality content.

For example, the immersive mixed reality experience may have the associated indicator 358 related to the collected data, e.g., d1A, d1B, and d1C for the device 381, d2A, d2B, and d2C for the device 382, and d3A, d3B, and d3C for the device 383. A datum, e.g., d1A, d1B, and d1C, d2A, d2B, and d2C, or d3A, d3B, and d3C may have an associated sensitivity level L to the user 310. The sensitivity level L may have a range of a finite set of discrete values, or a continuous range. For example, a sensitivity level L may form a set of {l1, . . . , ln} such that sensitivity level l1 denotes data at a least sensitivity level, sensitivity level l2 as a second sensitivity level that is more sensitive than the sensitivity level l1. Similarly, sensitivity level l3 and l4 are respectively at higher classification levels than the sensitivity level l2. In addition, an application to present the mixed reality content 359 may be in a set W representing the set of applications in a whitelist configuration known to be trustworthy as determined by the secure execution unit 340. For example, the whitelist application W may be published on a public block chain. Applications in the set W may have various security operations such as an attestation, whitelist check, antivirus scanning, firewall scan etc.

In embodiments, the OBU 315 further includes the navigation system 320, which may be coupled to the mixed reality content unit 318. The navigation system 320 is configured to choose a route among a plurality of routes for the CA/AD vehicle, based on the immersive mixed reality experience, e.g., the associated indicator 358, generated for the user based on the mixed reality content 359 presented to the user.

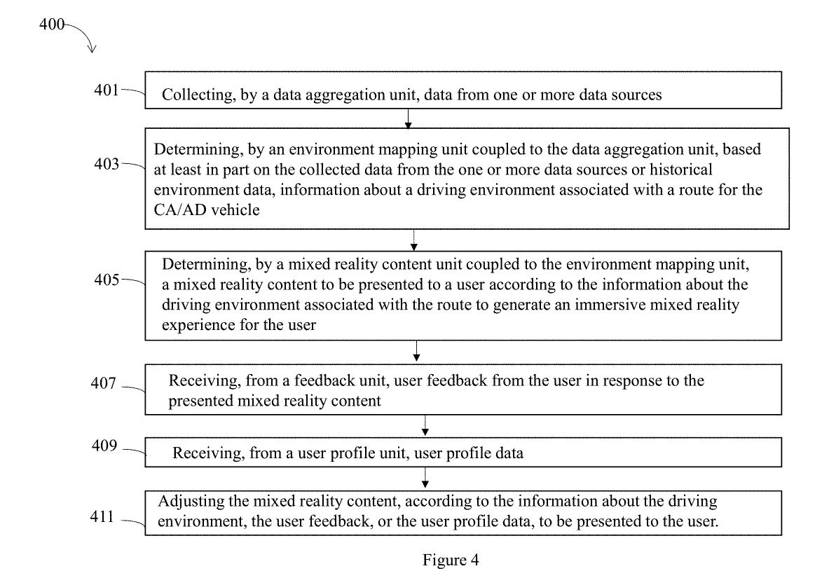

FIG. 4 illustrates an example process 400 for presenting a mixed reality content to a user of a CA/AD vehicle according to information about driving environment, in accordance with various embodiments. In embodiments, the process 400 may be a process performed by an OBU, e.g., the OBU 115, the OBU 215, or the OBU 315.

The process 400 may start at an interaction 401. During the interaction 401, a data aggregation unit of a CA/AD vehicle collects data from one or more data sources. For example, at the interaction 401, the data aggregation unit 316 may collect data from the one or more data sources 380.

During an interaction 403, an environment mapping unit of the CA/AD vehicle determines, based at least in part on the collected data from the one or more data sources or historical environment data, information about a driving environment associated with a route for the CA/AD vehicle. For example, at the interaction 403, the environment mapping unit 317 may determine, based at least in part on the collected data from the one or more data sources 380 or historical environment data, information about a driving environment associated with a route for the CA/AD vehicle 300.

During an interaction 405, a mixed reality content unit of the CA/AD vehicle determines a mixed reality content to be presented to a user according to the information about the driving environment associated with the route to generate an immersive mixed reality experience for the user. For example, at the interaction 405, the mixed reality content unit 318 may determine the mixed reality content 359 to be presented to the user 310 according to the information about the driving environment associated with the route to generate an immersive mixed reality experience for the user 310.

During an interaction 407, a feedback unit of the CA/AD vehicle receives user feedback from the user in response to the presented mixed reality content. For example, at the interaction 407, the feedback unit 313 may receive user feedback from the user 310 in response to the presented mixed reality content 359.

During an interaction 409, a user profile unit of the CA/AD vehicle provides user profile data. For example, at the interaction 409, the user profile unit 314 may provide user profile data.

During an interaction 411, the mixed reality content unit of the CA/AD vehicle adjusts the mixed reality content, according to the information about the driving environment, the user feedback, or the user profile data, to be presented to the user. For example, at the interaction 411, the mixed reality content unit 318 of the CA/AD vehicle 300 may adjust the mixed reality content 359, according to the information about the driving environment, the user feedback, or the user profile data, to be presented to the user.

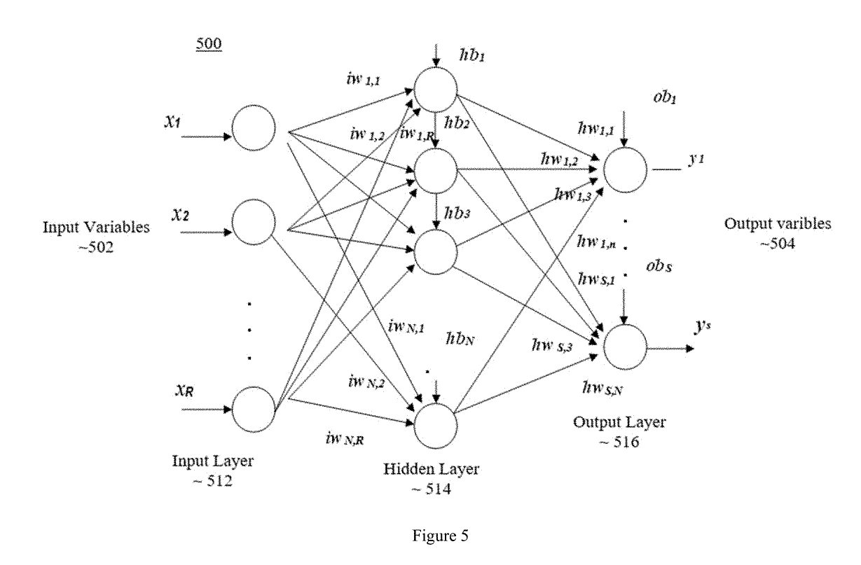

FIG. 5 illustrates an example neural network 500 suitable for use with present disclosure, in accordance with various embodiments. In embodiments, the neural network 500 may be used to implement various decisions in process 400, or made by an OBU, e.g., the OBU 115, the OBU 215, or the OBU 315. In particular, the neural network 500 may be used in environment mapping unit 317 in determining information about a driving environment associated with a route for the CA/AD vehicle, based at least in part on the collected data from the one or more data sources or historical environment data.

As shown, the neural network 500 may be a multilayer feedforward neural network (FNN) comprising an input layer 512, one or more hidden layers 514 and an output layer 516. Input layer 512 receives data of input variables (xᵢ) 502. Hidden layer(s) 514 processes the inputs, and eventually, output layer 516 outputs the determinations or assessments (yᵢ) 504. In one example implementation the input variables (xᵢ) 502 of the neural network are set as a vector containing the relevant variable data, while the output determination or assessment (yᵢ) 504 of the neural network are also as a vector.

Multilayer feedforward neural network (FNN) may be expressed through the following equations:

hoᵢ=f(Σⱼ₌₁^{R}(iw_{i,j}xⱼ)+hbᵢ), for i=1, . . . ,N

yᵢ=f(Σₖ₌₁^{N}(hw_{i,k}hoₖ)+obᵢ), for i=1, . . . ,S

where hoᵢ and yᵢ are the hidden layer variables and the final outputs, respectively. f( ) is typically a non-linear function, such as the sigmoid function or rectified linear (ReLu) function that mimics the neurons of the human brain. R is the number of inputs. N is the size of the hidden layer, or the number of neurons. S is the number of the outputs.

The goal of the FNN is to minimize an error function E between the network outputs and the desired targets, by adapting the network variables iw, hw, hb, and ob, via training, as follows:

E=Σₖ₌₁^{m}(Eₖ), where Eₖ=Σₚ₌₁^{s}(tₖₚ−yₖₚ)²

where yₖₚ and tₖₚ are the predicted and the target values of pth output unit for sample k, respectively, and m is the number of samples.

the input variables (xᵢ) 502 may include the collected data from one or more data sources or historical environment data. The output variables (yᵢ) 504 may include contents and/or attributes of a driving environment associated with a route for the CA/AD vehicle.

In this example, for simplicity of illustration, there is only one hidden layer in the neural network. In some other embodiments, there can be many layers of hidden layers. Furthermore, the neural network can be in some other types of topology, such as Convolution Neural Network (CNN) or Recurrent Neural Network (RNN).

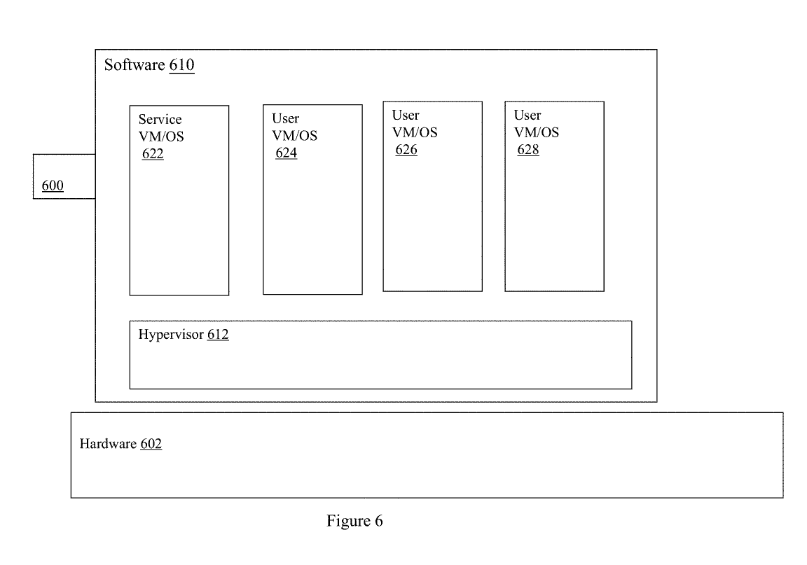

FIG. 6 illustrates a software component view of a system 600 to present a mixed reality content to a user according to information about driving environment, in accordance with various embodiments. As shown, for the embodiments, the system 600, which could implement functions, e.g., the process 400, performed by an OBU, e.g., the OBU 115, the OBU 215, or the OBU 315, includes hardware 602 and software 610. Software 610 includes hypervisor 612 hosting a number of virtual machines (VMs) 622-628. Hypervisor 612 is configured to host execution of VMs 622-628. The VMs 622-628 include a service VM 622 and a number of user VMs 624-628. Service VM 622 includes a service OS hosting execution of instrument cluster applications. User VMs 624-628 may include one or more user VMs having user OS hosting execution of a mixed reality content unit, e.g., the mixed reality content unit 318, e.g., functions of the data aggregation unit 316, the environment mapping unit 317, the user profile unit 314, the feedback unit 313, the secure execution unit 340, the navigation system 320, the storage device 350, and the mixed reality runtime unit 360.

In embodiments, elements 612-628 of software 610 may be any one of a number of these elements known in the art. For example, hypervisor 612 may be any one of a number of hypervisors known in the art, such as KVM, an open source hypervisor, Xen, available from Citrix Inc, of Fort Lauderdale, Fla., or VMware, available from VMware Inc of Palo Alto, Calif., and so forth. Similarly, service OS of service VM 622 and user OS of user VMs 624-628 may be any one of a number of OS known in the art, such as Linux, available e.g., from Red Hat Enterprise of Raliegh, N.C., or Android, available from Google of Mountain View, Calif.

FIG. 7 illustrates a hardware component view of a computing platform 700 to present a mixed reality content to a user according to information about driving environment, in accordance with various embodiments. As shown, the computing platform 700, which may be hardware 602 of FIG. 6, may include one or more SoCs 702, ROM 703 and system memory 704. Each SoCs 702 may include one or more processor cores (CPUs), one or more graphics processor units (GPU), one or more accelerators, such as computer vision (CV) and/or deep learning (DL) accelerators. ROM 703 may include BIOS 705. CPUs, GPUs, and CV/DL accelerators may be any one of a number of these elements known in the art. Similarly, ROM 703 and basic input/output system services (BIOS) 705 may be any one of a number of ROM and BIOS known in the art, and system memory 704 may be any one of a number of volatile storage known in the art.

Additionally, computing platform 700 may include persistent storage devices 706. Example of persistent storage devices 706 may include, but are not limited to, flash drives, hard drives, compact disc read-only memory (CD-ROM) and so forth. Further, computing platform 700 may include input/output devices 708 (such as display, keyboard, cursor control and so forth) communication interfaces 710 (such as network interface cards, modems and so forth), and sensors 720. Communication and I/O devices 708 may include any number of communication and I/O devices known in the art. Examples of communication devices may include, but are not limited to, networking interfaces for Bluetooth®, Near Field Communication (NFC), WiFi, Cellular communication (such as LTE, 4G, or 5G) and so forth. The elements may be coupled to each other via system bus 712, which may represent one or more buses. In the case of multiple buses, they may be bridged by one or more bus bridges (not shown).

Each of these elements may perform its conventional functions known in the art. In particular, ROM 703 may include BIOS 705 having a boot loader. System memory 704 and mass storage devices 706 may be employed to store a working copy and a permanent copy of the programming instructions implementing the operations associated with hypervisor 612, service/user OS of service/user VM 622-628, the process 400, and components of an OBU, e.g., the OBU 115, the OBU 215, or the OBU 315), collectively referred to as computational logic 722. The various elements may be implemented by assembler instructions supported by processor core(s) of SoCs 702 or high-level languages, such as, for example, C, that can be compiled into such instructions.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

FIG. 8 illustrates a storage medium having instructions for practicing methods described with references to FIGS. 1-7, in accordance with various embodiments. As shown, non-transitory computer-readable storage medium 802 may include a number of programming instructions 804. Programming instructions 804 may be configured to enable a device, e.g., computing platform 700, in response to execution of the programming instructions, to implement (aspects of) hypervisor 612, service/user OS of service/user VM 622-628, the process 400, and components of an OBU, e.g., the OBU 115, the OBU 215, or the OBU 315). In alternate embodiments, programming instructions 804 may be disposed on multiple computer-readable non-transitory storage media 802 instead. In still other embodiments, programming instructions 804 may be disposed on computer-readable transitory storage media 802, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 may include an apparatus for computer assisted or autonomous driving (CA/AD), comprising: a data aggregation unit, disposed in a CA/AD vehicle, to collect data from one or more data sources; an environment mapping unit, disposed in the CA/AD vehicle and coupled to the data aggregation unit, to determine, based at least in part on the collected data from the one or more data sources or historical environment data, information about a driving environment associated with a route for the CA/AD vehicle; and a mixed reality content unit, disposed in the CA/AD vehicle and coupled to the environment mapping unit, to determine a mixed reality content to be presented to a user according to the information about the driving environment associated with the route to generate an immersive mixed reality experience for the user.

Example 2 may include the apparatus of example 1 and/or some other examples herein, further comprising: a feedback unit, disposed in the CA/AD vehicle and coupled to the mixed reality content unit, to provide user feedback from the user in response to the presented mixed reality content, wherein the mixed reality content unit is to adjust the mixed reality content, according to the information about the driving environment and the user feedback, to be presented to the user.

Example 3 may include the apparatus of example 1 and/or some other examples herein, further comprising: a user profile unit, disposed in the CA/AD vehicle and coupled to the mixed reality content unit, to provide user profile data to the mixed reality content unit, wherein the mixed reality content unit is to adjust the mixed reality content, further according to the information about the driving environment and the user profile data, to be presented to the user, and wherein the user profile data includes responses from the user to one or more mixed reality contents, parameters configured for the user, risk tolerance level for the user, or information about quality of service (QoS) for the user.

Example 4 may include the apparatus of example 1 and/or some other examples herein, further comprising: a navigation system, disposed in the CA/AD vehicle and coupled to the mixed reality content unit, to choose the route among a plurality of routes for the CA/AD vehicle, based on the immersive mixed reality experience generated for the user based on the mixed reality content presented to the user.

Example 5 may include the apparatus of example 1 and/or some other examples herein, further comprising: a secure execution unit, disposed in the CA/AD vehicle and coupled to the mixed reality content unit, to manage licenses, or keys associated with the mixed reality content to be presented to the user.

Example 6 may include the apparatus of example 1 and/or some other examples herein, further comprising: a mixed reality runtime unit, disposed in the CA/AD vehicle and coupled to the mixed reality content unit to present the mixed reality content to the user.

Example 7 may include the apparatus of example 1 and/or some other examples herein, wherein the driving environment associated with the route includes information about real-time traffic on the route, information about a terrain along the route, or road conditions of the route, wherein the information about the real-time traffic on the route includes a position of the CA/AD vehicle relative to a driving lane, a speed of the CA/AD vehicle, an inter-vehicle distance of the CA/AD vehicle with another vehicle, a position with a lane or across lanes for the CA/AD vehicle, a choice of a lane among multiple lanes for the CA/AD vehicle, a degree of a turn to make for the CA/AD vehicle, a trajectory of the CA/AD vehicle, and wherein the information about the terrain along the route includes a slope of the route, one or more turns of the route, or one or more objects along the route.

Example 8 may include the apparatus of example 1 and/or some other examples herein, wherein the mixed reality content includes visual content, audio content, mechanical movements of one or more parts of the CA/AD vehicle, or air movements within or around the CA/AD vehicle.

Example 9 may include the apparatus of example 1 and/or some other examples herein, wherein the data from the one or more data sources includes user input data, sensory data, crowd-sourced input data from another device, another vehicle, others users, or a roadside unit (RSU).

Example 10 may include the apparatus of example 9 and/or some other examples herein, wherein the sensory data include one or more selected from radar data, ultrasonic sensor data, video sensor data, camera data, light detection and ranging (LiDAR) data, global positioning system (GPS) data, or inertial data.

Example 11 may include the apparatus of example 9 and/or some other examples herein, wherein the RSU is a selected one of a road embedded reflector, a smart street or traffic light, a road side tag, an evolved node B (eNB) type RSU, or a stationary user equipment (UE) type RSU.

Example 12 may include the apparatus of example 1 and/or some other examples herein, wherein the immersive mixed reality experience is an indicator generated based on the collected data from the one or more data sources where a datum has an associated sensitivity level to the user, an application to present the mixed reality content, the mixed reality content presented to the user, user feedback from the user in response to the presented mixed reality content, user profile data, a security measure of the application, a risk factor for the mixed reality content, or an opportunity cost for the mixed reality content.

Example 13 may include the apparatus of example 1 and/or some other examples herein, wherein the CA/AD vehicle is a selected one of a commercial truck, a light duty car, a sport utility vehicle (SUV), a light vehicle, a heavy duty vehicle, a pickup truck, a van, a car, or a motorcycle.

Example 14 may include the apparatus of example 1 and/or some other examples herein, wherein the apparatus is a vehicle onboard unit (OBU) disposed in the CA/AD vehicle.

Example 15 may include the apparatus of example 14 and/or some other examples herein, wherein the apparatus is the CA/AD vehicle comprising the vehicle onboard unit (OBU).

Example 16 may include a method for computer assisted or autonomous driving (CA/AD), comprising: receiving, by an on board unit (OBU) of a CA/AD vehicle, data from one or more data sources; determining, by the OBU, based at least in part on the collected data from the one or more data sources or historical environment data, information about a driving environment associated with a route for the CA/AD vehicle; and determining, by the OBU, a mixed reality content to be presented to a user according to the information about the driving environment associated with the route to generate an immersive mixed reality experience for the user.

Example 17 may include the method of example 16 and/or some other examples herein, further comprising: receiving, by the OBU, user feedback from the user in response to the presented mixed reality content; receiving, from a user profile unit of the CA/AD vehicle, user profile data; and adjusting, by the mixed reality content unit of the CA/AD vehicle, the mixed reality content of the CA/AD vehicle, according to the information about the driving environment, the user feedback, or the user profile data, to be presented to the user.

Example 18 may include the method of example 16 and/or some other examples herein, further comprising: selecting, by a navigation system of the CA/AD vehicle, the route among a plurality of routes for the CA/AD vehicle, based on the immersive mixed reality experience generated for the user based on the mixed reality content presented to the user.

Example 19 may include the method of example 16 and/or some other examples herein, further comprising: presenting, by a mixed reality runtime unit of the CA/AD vehicle, the mixed reality content to the user.

Example 20 may include one or more non-transitory computer-readable media comprising instructions that cause a computer assisted or autonomous driving (CA/AD) system in a CA/AD vehicle, in response to execution of the instructions by the CA/AD system, to: collect data from one or more data sources; and determine a mixed reality content to be presented to a user according to information about a driving environment associated with a route determined based on the data collected from the one or more data sources, to generate an immersive mixed reality experience for the user.

Example 21 may include the one or more non-transitory computer-readable media of example 20 and/or some other examples herein, wherein the instructions further cause the CA/AD system in the CA/AD vehicle, in response to execution of the instructions by the CA/AD system, to: receive user feedback from the user in response to the presented mixed reality content; receive user profile data; and adjust the mixed reality content, according to the information about the driving environment, the user feedback, or the user profile data, to be presented to the user.

Example 22 may include the one or more non-transitory computer-readable media of example 20 and/or some other examples herein, wherein the driving environment associated with the route includes information about real-time traffic on the route, information about a terrain along the route, or road conditions of the route, wherein the information about the real-time traffic on the route includes a position of the CA/AD vehicle relative to a driving lane, a speed of the CA/AD vehicle, an inter-vehicle distance of the CA/AD vehicle with another vehicle, a position with a lane or across lanes for the CA/AD vehicle, a choice of a lane among multiple lanes for the CA/AD vehicle, a degree of a turn to make for the CA/AD vehicle, a trajectory of the CA/AD vehicle, and wherein the information about a terrain along the route includes a slope of the route, one or more turns of the route, or one or more objects along the route.

Example 23 may include the one or more non-transitory computer-readable media of example 20 and/or some other examples herein, wherein the mixed reality content includes visual content, audio content, mechanical movements of one or more parts of the CA/AD vehicle, or air movements within or around CA/AD vehicle.

Example 24 may include the one or more non-transitory computer-readable media of example 20 and/or some other examples herein, wherein the data from the one or more data sources includes user input data, sensory data, crowd-sourced input data from another device, another vehicle, others users, or a roadside unit (RSU).

Example 25 may include the one or more non-transitory computer-readable media of example 20 and/or some other examples herein, wherein the immersive mixed reality experience is an indicator generated based on the collected data from the one or more data sources where a datum has an associated sensitivity level to the user, an application to present the mixed reality content, the mixed reality content presented to the user, user feedback from the user in response to the presented mixed reality content, user profile data, a security measure of the application, a risk factor for the mixed reality content, or an opportunity cost for the mixed reality content.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus for computer assisted or autonomous driving (CA/AD), comprising:
a data aggregation unit, disposed in a CA/AD vehicle, to collect data from one or more data sources;
an environment mapping unit, disposed in the CA/AD vehicle and coupled to the data aggregation unit, to determine, based at least in part on the collected data from the one or more data sources or historical environment data, information about a driving environment associated with a route for the CA/AD vehicle; and
a mixed reality content unit, disposed in the CA/AD vehicle and coupled to the environment mapping unit, to determine a mixed reality content to be presented to a user according to the information about the driving environment associated with the route to generate an immersive mixed reality experience for the user.

2. The apparatus of claim 1, further comprising:
a feedback unit, disposed in the CA/AD vehicle and coupled to the mixed reality content unit, to provide user feedback from the user in response to the presented mixed reality content, wherein the mixed reality content unit is to adjust the mixed reality content, according to the information about the driving environment and the user feedback, to be presented to the user.

3. The apparatus of claim 1, further comprising:
a user profile unit, disposed in the CA/AD vehicle and coupled to the mixed reality content unit, to provide user profile data to the mixed reality content unit, wherein the mixed reality content unit is to adjust the mixed reality content, further according to the information about the driving environment and the user profile data, to be presented to the user, and wherein the user profile data includes responses from the user to one or more mixed reality contents, parameters configured for the user, risk tolerance level for the user, or information about quality of service (QoS) for the user.

4. The apparatus of claim 1, further comprising:
a navigation system, disposed in the CA/AD vehicle and coupled to the mixed reality content unit, to choose the route among a plurality of routes for the CA/AD vehicle, based on the immersive mixed reality experience generated for the user based on the mixed reality content presented to the user.

5. The apparatus of claim 1, further comprising:
a secure execution unit, disposed in the CA/AD vehicle and coupled to the mixed reality content unit, to manage licenses, or keys associated with the mixed reality content to be presented to the user.

6. The apparatus of claim 1, further comprising:
a mixed reality runtime unit, disposed in the CA/AD vehicle and coupled to the mixed reality content unit to present the mixed reality content to the user.

7. The apparatus of claim 1, wherein the driving environment associated with the route includes information about real-time traffic on the route, information about a terrain along the route, or road conditions of the route, wherein the information about the real-time traffic on the route includes a position of the CA/AD vehicle relative to a driving lane, a speed of the CA/AD vehicle, an inter-vehicle distance of the CA/AD vehicle with another vehicle, a position with a lane or across lanes for the CA/AD vehicle, a choice of a lane among multiple lanes for the CA/AD vehicle, a degree of a turn to make for the CA/AD vehicle, a trajectory of the CA/AD vehicle, and wherein the information about the terrain along the route includes a slope of the route, one or more turns of the route, or one or more objects along the route.

8. The apparatus of claim 1, wherein the mixed reality content includes visual content, audio content, mechanical movements of one or more parts of the CA/AD vehicle, or air movements within or around the CA/AD vehicle.

9. The apparatus of claim 1, wherein the data from the one or more data sources includes user input data, sensory data, crowd-sourced input data from another device, another vehicle, others users, or a roadside unit (RSU).

10. The apparatus of claim 9, wherein the sensory data include one or more selected from radar data, ultrasonic sensor data, video sensor data, camera data, light detection and ranging (LiDAR) data, global positioning system (GPS) data, or inertial data.

11. The apparatus of the claim 9, wherein the RSU is a selected one of a road embedded reflector, a smart street or traffic light, a road side tag, an evolved node B (eNB) type RSU, or a stationary user equipment (UE) type RSU.

12. The apparatus of claim 1, wherein the immersive mixed reality experience is an indicator generated based on the collected data from the one or more data sources where a datum has an associated sensitivity level to the user, an application to present the mixed reality content, the mixed reality content presented to the user, user feedback from the user in response to the presented mixed reality content, user profile data, a security measure of the application, a risk factor for the mixed reality content, or an opportunity cost for the mixed reality content.

13. The apparatus of claim 1, wherein the CA/AD vehicle is a selected one of a commercial truck, a light duty car, a sport utility vehicle (SUV), a light vehicle, a heavy duty vehicle, a pickup truck, a van, a car, or a motorcycle.

14. The apparatus of claim 1, wherein the apparatus is a vehicle onboard unit (OBU) disposed in the CA/AD vehicle.

15. The apparatus of claim 14, wherein the apparatus is the CA/AD vehicle comprising the vehicle onboard unit (OBU).

16. A method for computer assisted or autonomous driving (CA/AD), comprising:
receiving, by an on board unit (OBU) of a CA/AD vehicle, data from one or more data sources;
determining, by the OBU, based at least in part on the collected data from the one or more data sources or historical environment data, information about a driving environment associated with a route for the CA/AD vehicle; and
determining, by the OBU, a mixed reality content to be presented to a user according to the information about the driving environment associated with the route to generate an immersive mixed reality experience for the user.

17. The method of claim 16, further comprising:
receiving, by the OBU, user feedback from the user in response to the presented mixed reality content;
receiving, from a user profile unit of the CA/AD vehicle, user profile data; and
adjusting, by the mixed reality content unit of the CA/AD vehicle, the mixed reality content of the CA/AD vehicle, according to the information about the driving environment, the user feedback, or the user profile data, to be presented to the user.

18. The method of claim 16, further comprising:
selecting, by a navigation system of the CA/AD vehicle, the route among a plurality of routes for the CA/AD vehicle, based on the immersive mixed reality experience generated for the user based on the mixed reality content presented to the user.

19. The method of claim 16, further comprising:
presenting, by a mixed reality runtime unit of the CA/AD vehicle, the mixed reality content to the user.

20. One or more non-transitory computer-readable media comprising instructions that cause a computer assisted or autonomous driving (CA/AD) system in a CA/AD vehicle, in response to execution of the instructions by the CA/AD system, to:
collect data from one or more data sources; and
determine a mixed reality content to be presented to a user according to information about a driving environment associated with a route determined based on the data collected from the one or more data sources, to generate an immersive mixed reality experience for the user.

21. The one or more non-transitory computer-readable media of claim 20, wherein the instructions further cause the CA/AD system in the CA/AD vehicle, in response to execution of the instructions by the CA/AD system, to:
receive user feedback from the user in response to the presented mixed reality content;
receive user profile data; and
adjust the mixed reality content, according to the information about the driving environment, the user feedback, or the user profile data, to be presented to the user.

22. The one or more non-transitory computer-readable media of claim 20, wherein the driving environment associated with the route includes information about real-time traffic on the route, information about a terrain along the route, or road conditions of the route, wherein the information about the real-time traffic on the route includes a position of the CA/AD vehicle relative to a driving lane, a speed of the CA/AD vehicle, an inter-vehicle distance of the CA/AD vehicle with another vehicle, a position with a lane or across lanes for the CA/AD vehicle, a choice of a lane among multiple lanes for the CA/AD vehicle, a degree of a turn to make for the CA/AD vehicle, a trajectory of the CA/AD vehicle, and wherein the information about a terrain along the route includes a slope of the route, one or more turns of the route, or one or more objects along the route.

23. The one or more non-transitory computer-readable media of claim 20, wherein the mixed reality content includes visual content, audio content, mechanical movements of one or more parts of the CA/AD vehicle, or air movements within or around CA/AD vehicle.

24. The one or more non-transitory computer-readable media of claim 20, wherein the data from the one or more data sources includes user input data, sensory data, crowd-sourced input data from another device, another vehicle, others users, or a roadside unit (RSU).

25. The one or more non-transitory computer-readable media of claim 20, wherein the immersive mixed reality experience is an indicator generated based on the collected data from the one or more data sources where a datum has an associated sensitivity level to the user, an application to present the mixed reality content, the mixed reality content presented to the user, user feedback from the user in response to the presented mixed reality content, user profile data, a security measure of the application, a risk factor for the mixed reality content, or an opportunity cost for the mixed reality content.
